(19) United States
(12) Patent Application Publication
(10) Pub. No.: US 2024/0157842 A1
(43) Pub. Date: May 16, 2024

(54) POWER DISTRIBUTION SYSTEM

(71) Applicant: L-Charge Holding Limited, London (GB)

(72) Inventors: Dmitry Lashin, London (GB); Michael Isaev, Moscow (RU)

(21) Appl. No.: 18/509,015

(22) Filed: Nov. 14, 2023

(30) Foreign Application Priority Data
Nov. 15, 2022 (GB) 2217033.6

(51) Int. Cl. B60L 58/10; B60K 6/26; B60K 6/28; B60L 53/16

(52) U.S. Cl. CPC B60L 58/10; B60K 6/26; B60K 6/28; B60L 53/16; B60L 2210/10; B60Y 2200/92

(57) ABSTRACT

A power distribution system (100, 200) is disclosed, comprising: a charging port (110, 210) for connection to an electric vehicle, EV, battery; a gas engine generator, GEG, (102, 202) configured to generate a first current output; an array (104, 204) of accumulator batteries configured to generate a second current output; a direct current to direct current, DC-DC, converter (106, 206) configured to receive the first and second current outputs and to output a regulated power supply to the charging port; and a controller (108, 208) configured to independently control: the GEG to determine the first current output; the array to determine the second current output; and the DC-DC converter to determine the regulated power supply.

### RELATED APPLICATIONS

This application is based upon and claims the benefit of priority from United Kingdom Application No. GB2217033.6, filed Nov. 15, 2022, the entire contents of which are incorporated herein by reference.

### FIELD OF THE INVENTION

The present invention relates to a power distribution system for charging electric vehicles. The disclosure is particularly applicable to an off-grid power system that generates its own power.

### BACKGROUND

Known electric vehicle, EV, charging stations typically require connection to a mains electricity grid, which can be difficult to implement in developed urban settings due to planning restrictions or logistical hurdles. In more rural or remote settings, it can be difficult to determine a suitable location to install an EV charging station.

To overcome these logistical problems, mobile charging stations have been considered. Such a mobile station may have its own engine to generate power and/or a supercapacitor for storing electrical charge. However, a problem of known mobile charging stations is providing an effective and efficient delivery of electrical charge to EV batteries.

An object of the invention is to improve power distribution in off-grid EV charging systems.

### SUMMARY OF INVENTION

According to an aspect of the present invention, there is provided a power distribution system comprising: a charging port for connection to an electric vehicle, EV, battery; a gas engine generator, GEG, configured to generate a first current output; an array of accumulator batteries configured to generate a second current output; a direct current to direct current, DC-DC, converter configured to receive the first and second current outputs and to output a regulated power supply to the charging port; and a controller configured to independently control: the GEG to determine the first current output; the array to determine the second current output; and the DC-DC converter to determine the regulated power supply.

In this way, the generation and delivery of power by the present power distribution system to a connected electric vehicle or battery can be better balanced and controlled, and in turn improve the overall efficiency, safety and lifetime of the system. The gas engine generator utilises a gas fuel, such as natural gas or hydrogen, to generate electrical power. This power can be delivered to the array of accumulator batteries to charge the batteries, as well as to charge an EV battery connected to the charging port. The battery array, also known as a power bus, stores received electrical energy/power (which can also be from sources other than the GEG, such as a renewable power source or a mains supply) in the individual batteries, or cells.

When an EV battery is connected to the charging port, electrical power is output from the GEG and the battery array to the DC-DC converter as a combination of two current outputs, and the DC-DC converter converts the combined current outputs into a regulated power supply to charge the EV battery through the charging port.

The controller of the power distribution system measures the first and second current outputs from the respective GEG and array, and is able to independently control the GEG and/or the array to increase or decrease the respective current output. For example, the controller may send a signal to the GEG to generate more power and thus increase the first current output or vice versa. In another example, the controller may send a signal to the array to increase or decrease the second current output. The controller may be a known programmable logic controller, such as a Phoenix Contact controller.

The controller also controls the DC-DC converter by determining the capacity of the power supply that is output to the charging port. For example, the controller may set an output voltage level of the DC-DC converter. The controller may be configured to utilise different data from the various components across the power distribution system and/or a connected electric vehicle/battery in order to determine what level the regulated power supply should be.

It should therefore be appreciated that the present power distribution system controls the power generation, supply and conversion in a dynamic way to provide an optimised solution for EV battery charging. As will be explained in detail below, the present invention allows the controller to balance the current outputs of the GEG and the battery array to best utilise the two power sources according to the charging requirements of a connected EV battery whilst also managing the GEG and array in a most efficient and effective way.

Preferably, the power distribution system further comprises a GEG voltage regulator, wherein the GEG voltage regulator is controllable by the controller. In this way, the first current output from the GEG may be controlled by varying the voltage level of the power output from the GEG. Known gas engine generators may include an in-built automatic voltage regulator as a safety mechanism for the GEG. The present GEG voltage regulator may be the in-built regulator that is configured to be controlled by the controller, or alternatively a separate GEG output voltage regulator may be included. As will be appreciated by a person skilled in the art, the operating parameters of a voltage regulator can be determined by a controller according to design requirements.

Preferably, the array comprises a battery management system, BMS, for each accumulator battery, and wherein the second current output is controlled using information from the battery management systems in the array. Each BMS is configured to sense, or measure, certain parameters or conditions of a respective battery, which can provide information relating to the operational performance and limits of that battery.

The second current output of the battery array can be measured before it is received by the DC-DC converter. The measured second current output may be different to an expected output from the array, and/or may be within a range of a discharge capacity of the batteries. The controller may calculate the discharge capacity range of the battery array using the information from the BMS of each accumulator battery in the array, and may send a control signal to the array or one or more individual accumulator batteries in the array to vary the second current output accordingly. The BMS information may also inform the controller that one or more accumulator batteries are not functioning properly/broken, which may in turn influence the control signal of the controller to the array.

Preferably, the information comprises a maximum voltage and a minimum voltage of each of the accumulator batteries, and wherein the second current output is determined using a highest maximum voltage and/or a lowest minimum voltage across all of the accumulator batteries. The maximum and minimum voltages of each battery/cell provide state of charge information to the controller, and indicates a discharge capacity of the one or more batteries. The controller may then send a control signal to the array to increase the second current voltage according to operational requirements. As will be appreciated, it may be more efficient and ‘greener’ to draw a greater current output from the battery array than the GEG when charging an EV battery so more effectively use the stored power in the array as well as reduce the running of the GEG. However, the GEG itself may have an optimal or preferred operating range which may influence how much power/the current output drawn from the battery array. For example, operating the GEG at a low power/current output may be fuel-inefficient, and excessive stop-starts of the GEG may reduce the overall lifetime of the GEG or components of the GEG.

Typically, it has been found that as the lowest minimum voltage across all of the accumulator batteries decreases, the second current output can be increased. Similarly, as the highest maximum voltage across all of the batteries increases, the second current output can be decreased. In these cases, the second current output should be understood to be the maximum or recommended maximum charging current output of the array (that is, the output value the controller requests the battery array to output).

As an example, limitations may be imposed on a discharge current of the battery array based on the battery array state of discharge information and its monitored load voltage. To put it in another way, the power distribution system may monitor the battery array output voltage and, to prevent a voltage drop below the minimum voltage of a cell/accumulator battery, the controller reduces the power output from the battery array, which in turn limits the available power for charging the EV battery.

Preferably, the information comprises a maximum temperature and a minimum temperature of each of the accumulator batteries, and wherein the second current output is determined using a highest maximum temperature and/or a lowest minimum temperature across all of the accumulator batteries. In this way, the operational lifetime of a battery may be increased or optimised. As will be understood by the skilled person, the operating parameters of a battery are affected by temperature and running a battery at too high a temperature may lead to unnecessary damage, such as battery corrosion, in the battery that shortens the life of the battery.

When the temperature is too cold, the current output of the battery array may be lower than the expected output, i.e. a measured second current output being lower than the value for the second current output in a control signal from the controller to the array. In such a case, the received current outputs at the DC-DC converter may be lower than what is required and the controller may in turn send further control signals to the GEG and the array to rebalance the current outputs to optimise a charging time for a connected EV battery for a period of time. The controller may, at a later time after determining that the lowest minimum temperature of the batteries has increased, further control the current outputs of the GEG and array in a dynamic way to effectively utilise the stored power in the array.

For example, when a battery is charged with a gas engine, a GEG regulator may be set to the maximum charging current of that battery, whilst taking into account the battery temperature and its actual voltage. When the maximum voltage of the battery is exceeded, the GEG regulator may limit the voltage. In the case of low temperatures of the battery, controller may also control the GEG to limit the charging current and allow the battery to heat up.

Preferably, the accumulator batteries are connected in series in the array. In this way, the overall voltage of the array can be increased. Preferably, the array comprises eight accumulator batteries. Each accumulator battery may typically provide a normal charging voltage of 64 V battery, where the battery comprises 20 cells each having a charging voltage of 3.2 V. In this way, the overall typical charging voltage of the array is 512 V, which in practice may provide a maximum charging voltage of up to 584 V. Standard EV batteries have a 400 V or 800 V charge capability/capacity, and it has been advantageously found that providing a charging voltage toward the middle (i.e. approximately 600 V) of the two capacities offers a flexible arrangement that accommodates both EV battery charge capacities.

In order to operate the GEG efficiently, the GEG should be operated at a minimum of 60 to 70% operational power capacity. The controller may be set to turn off GEG (that is to stop the GEG from running) when the maximum current output delivered to the battery array for charging multiplied by the output voltage of the GEG is less than 30% of the operational capacity of the GEG. Advantageously, this reduces any unnecessary stop-starts of the GEG and extends the operational lifetime of the GEG. In addition, this ensures that when the GEG is running, power generated by the GEG is being efficiently used to charge the battery array and/or deliver power to the DC-DC converter and connected EV battery.

Preferably, the controller is configured to determine a maximum input power capacity of an EV battery connected the charging port. Preferably, the controller is configured to control the DC-DC converter to output a maximum regulated power supply to the charging port, preferably wherein the maximum regulated power supply matches the maximum input power capacity. In this way, the controller can adjust the current outputs of the GEG and array and the DC-DC converter to provide an optimum charging power supply to the charging port. It is possible that the maximum input power capacity of an EV battery is greater than the maximum regulated power supply that can be provided by the power distribution system. In this case, the controller may simply control the GEG and battery array to each output the maximum current output possible.

Preferably, the power distribution system further comprises a fuel supply, preferably wherein the fuel comprises one or more of: natural gas, liquefied natural gas, LNG, biofuel, hydrogen, and/or a hydrogen-methane blend. In this way, the GEG may be operated in a more versatile and green way. Furthermore, the fuel supply may be a self-contained supply that is not connected to a mains supply. This allows the power distribution system to be an “off-grid” which provides a more versatile charging solution that can be rapidly deployed in various different situations, e.g. an urban environment where connection to a mains supply would be logistically complicated or a rural environment where there is no mains supply at all.

Preferably, the power distribution system further comprises a renewable energy system configured to charge the array and/or deliver a third current output to the DC-DC converter, wherein the renewable energy system is controllable by the controller. For example, the renewable energy system may comprise one or more of a solar power, wind power, hydro power or biofuel energy system to provide an additional power to the system. Preferably, the controller may be configured to prioritise the use of the power/current output over the GEG and/or battery array. As another example, the controller may limit the operation of the GEG when the state of charge of the battery array has reached a predetermined value, e.g. 80% charge, to allow the remaining 20% to be charged solely by the renewable energy system.

Preferably, the power distribution system is mounted on a vehicle or vessel, preferably wherein an engine of the vehicle or vessel is configured to charge the array and/or deliver a further current output to the DC-DC converter. In this way, a further power source is provided to the power distribution system which “self-charges” while the vehicle or vessel is being run. A mounted power distribution system also offers the off-grid solution described above, which allows the system to be driven to an electric vehicle requiring a charge (e.g. a stranded vehicle/vessel).

Preferably, the power distribution system further comprises a cooling system. In this way, the different components of the system, including the DC-DC converter, the battery array, the GEG engine, or intercooler of the GEG, may be effectively cooled for operation. Preferably, the power distribution system is mounted on a vessel, and wherein the cooling system is configured to exchange heat with water surrounding the vessel. In this way, the water (e.g. the river, lake, sea or ocean) on which the vessel is floating can be routed into the system to provide additional heat exchange for the cooling system.

Preferably, the power distribution system further comprises a LNG supply system, wherein the cooling system is configured to exchange heat with liquefied natural gas of the LNG supply system before vaporisation. As will be understood, liquefied natural gas is typically stored in a cryogenic tank and is directed to an evaporator or vaporiser component (also known as a high-pressure accumulator) to be heated or otherwise vaporised before it is further directed to an engine for power generation. The piping between the cryogenic tank and the evaporator can be effectively routed to provide additional heat exchange with corresponding heat exchange piping of the cooling system.

According to another aspect of the invention, there is provided a method of providing a regulated power supply for an electric vehicle, EV, battery, comprising: providing a gas engine generator, GEG, configured to generate a first current output; providing an array of accumulator batteries configured to generate a second current output; controlling, by a controller, the GEG to output the first current output; controlling, by the controller, the array to output the second current output; receiving, at a direct current to direct current, DC-DC, converter the first and second current outputs; and controlling, by the controller, the DC-DC converter to output a regulated power supply to a charging port.

According to yet another aspect of the invention, there is provided a non-transitory computer-readable storage medium storing instructions thereon which, when executed by a processor in a controller, cause the processor to perform a method of providing a regulated power supply for an electric vehicle, EV, battery, the method comprising: controlling a gas engine generator, GEG to output a first current output; controlling an array of accumulator batteries to output a second current output; and controlling a direct current to direct current, DC-DC, converter configured to receive the first and second current outputs to output a regulated power supply to a charging port.

### BRIEF DESCRIPTION OF DRAWINGS

Embodiments of the invention are now described, by way of example, with reference to the drawings, in which:

FIGS. 1 is a schematic view of a power distribution system according to the present invention;

FIG. 2 is a schematic view another power distribution system according to the present invention;

FIG. 3 is a schematic view of a cooling system according to another aspect of the present invention.

### DETAILED DESCRIPTION

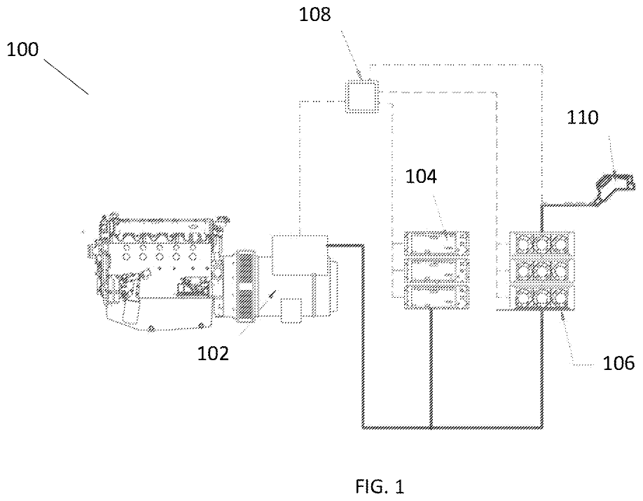

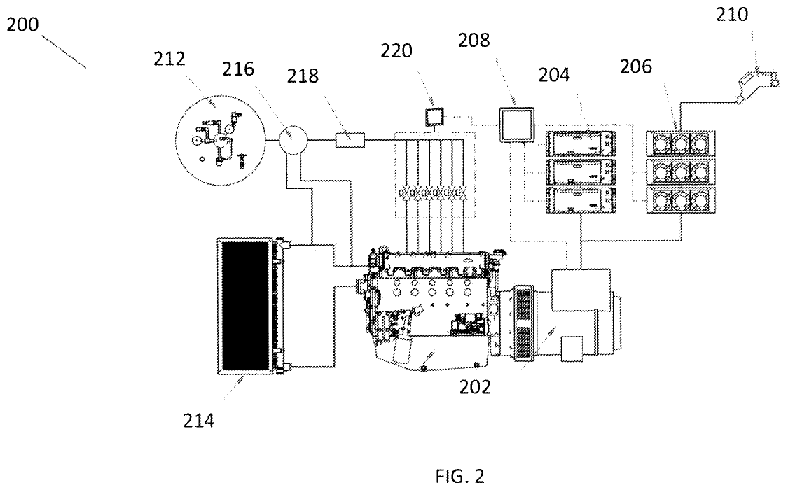

FIG. 1 shows a schematic view of the power distribution system 100 of the present invention. The system 100 includes a gas engine generator 102 (GEG), an array 104 of accumulator batteries (also known as a power bus), a direct current-to-direct current converter 106 (DC-DC converter), a controller 108, and a charging port 110. The system 100 may be deployed as a stationary unit, for example, in a petrol or gas station forecourt or a carpark/parking lot. Alternatively, as will be explained in reference to FIG. 2, the system may be mounted on a vehicle or vessel to provide a mobile charging unit.

The gas engine generator 102 consumes a gas fuel, such as natural gas, LNG stored in cryogenic tanks, hydrogen, or a hydrogen-methane blend, to generate power. The GEG may generate power of 300 to 1000 kW.

The generated power may be used to charge the power bus 104 and/or to charge an electric vehicle (EV) battery that is connected to the system 100 at the charging port 110. The power is generated with a particular current, and the controller 108 can control the GEG to vary the current output. For example, the GEG may include a voltage regulator which maintains a constant voltage of the generated power. The controller 108 may set the voltage at which the generated power is delivered to the array 104 or DC-DC converter 106, which determines the current output accordingly.

The power bus 104 is an array of accumulator batteries, in which each accumulator battery includes a plurality of cells which can store and deliver electrical power. The power bus 104 is configured to receive generated power 104 from the GEG to charge the accumulator batteries. The charged power bus 104 can then be used to charge a connected EV battery through the charging port 110, and may provide up to 100% of the charging power for the EV battery. Alternatively, the power bus 104 can work in combination with the GEG 102 to supply the charging power. As will be understood, if the accumulator batteries in the array 104 have all been fully discharged, only generated power from the GEG would be available for charging the connected EV battery.

Each accumulator battery in the array includes a battery management system (BMS, not shown) which provides battery information for the cells in the accumulator battery such as maximum and minimum temperatures of each cell, and maximum and minimum voltages of each cell. This information is monitored by the controller 108 and the controller 108 may in turn determine and control the current output of the array 104 (that is the current of the power from the power bus 104 to the DC-DC converter 106). For example, the controller 108 may determine a current output of the whole array 104 based on the lowest minimum cell voltage reading from all of the BMSs. As the minimum cell voltage decreases, the current output of the array 104 may be increased, and as the minimum cell voltage increases, the current output of the array 104 may be decreased.

The accumulator batteries in the array 104 can be readily removed from the system 100 for maintenance, repair, or alternatively, to be replaced with similar accumulator batteries on a mobile charging unit (as will be described in reference to FIG. 2), where the mobile charging vehicle/vessel may go on to bring a power charging function to any destination of choice.

As will be appreciated, the current output of the array 104 is a tunable parameter that is controlled in consideration of the current output of the GEG 102 (which as explained above, can be controlled by voltage regulation).

Power from the GEG 102 and the power bus 104 is delivered to the DC-DC converter 106 (which may include a plurality of DC-DC converters). As will be understood by the skilled person, the DC-DC converter is configured to convert the received power from the GEG 102 and the power bus 104 from one or more voltages to a regulated power output having a single voltage level. This regulated power output is directed to the charging port 110 for charging a connected EV battery. The controller 108 is configured to set the output voltage level of the regulated power output.

The controller 108 is also connected to the charging port 110 to receive information from an electric vehicle or electric vehicle battery that is connected to the charging port 110. Information may include a recommended or maximum charging capacity of the connected EV battery, as well as the state-of-charge of the battery. Based on the information received from a connected battery, the controller 108 is able to balance the current outputs of the GEG 102 and array 104 and the regulated power output of the DC-DC converter 106 to optimise the power distribution of the system 100 and maintain effective operation of the GEG 102 to improve the lifetime, efficiency of the GEG 102 whilst reducing any unnecessary polluting emissions.

A specific example of the power distribution system 100 is described below. The system 100 provides a power output of 120 kW based on a GEG 102 power of 60 kW and the array 104 includes LiFePo accumulator batteries of 100 A*h, 54 kW*h 538V 1 C discharge.

After the charging port 110 connected to an electric vehicle, the initialization process takes place according to standard combined charging system (CCS) protocols. In this process, the controller 108 determines the available power output of the system 100, and the connected electric vehicle, based on the available data, and requests in response charging values of the EV battery in terms of voltage and current (i.e. the optimal power requirements the EV would like to receive).

In this example the charging process starts from minimal power outputs of 1-5 kW from the battery array 104 (in another example the charging process may start with power output from the GEG 102). The system 100 then gradually increases the power output, loading the accumulator batteries, until the available power output (for example 30 kW) of the array 104 is reached. The GEG 102 is then engaged, controlled by the controller 108 (by sending a control signal to a GEG voltage regulator). The controller 108 sends the GEG current output value to the GEG regulator, which may be calculated as follows:

I_{gen}=(P_{charg·stat·}+P_{batt})/U_{gen}<P_{gen max},

where,
I_{gen} is the GEG current output;
P_{charg·stat·}is the power output of the system;
P_{batt} is the power to charge the battery array;
U_{gen} is the GEG voltage;
P_{gen max} is the maximum power of the generator.

As the power output of the system increases, the voltages of the GEG 102 and battery array 104 may vary constantly between 580V to 530V depending on the battery array loading. For example, when the available power of the system 100 approaches the maximum power of the GEG 102 of 60 kW, the voltage of the battery array 104 may be approximately 560V. However, as the battery array 104 discharges, the voltage starts may drop to 538V and below. The controller 108 in response may thus control the GEG regulator to reduce the GEG output current to compensate against any excessive load acting on the GEG 102, caused by the voltage drop of the array 104.

The power supply for the electric vehicle increases or builds up until the system 100 reaches the maximum available power of the battery of 60 kW with a limiting current at 111 A. In this example, when the maximum or optimum power supply of the system 100 is reached, the output parameters are as follows: bus voltage 538V, GEG current 111 A, battery array current 111 A. The bus voltage is the combined output voltages of the GEG 102 and the array 104. The system 100 is thus able to provide the maximum power output of 120 kW in this way by balancing the current outputs of the GEG 102 and the battery array 104.

However, it has been found that as the battery array 104 discharges, the battery voltage decreases slowly until the array 104 reaches a residual capacity of about 20%. At this point, the voltage decrease/drop in the battery array 104 accelerates significantly. Therefore, in response, the controller 108 is able to reduce the available power supply for charging from 120 kW (i.e. the maximum power output) until the battery voltage stabilizes to the permissible minimum level. In other words, when the residual capacity of the battery array 104 is less than 20%, the system 100 decreases the power output for charging an EV battery away from the maximum capacity of 120 kW. As will be apparent to the skilled person, when the battery array is fully discharged, the power or current output of the array 104 will be zero, and the only available charging power of the system will be that of the GEG (that is 60 kW).

In another specific example, where the electric vehicle does not request the full power of the system 100 (i.e. 120 kW) and, for example only requires 80 kW, the controller 108 may not change the current output for the GEG 102 (i.e. 111 A) and continue maximally loading the GEG for a 60 kW power output, and the controller 108 may control the battery array 104 to provide the remaining 20 kW of power.

In another example, when less power is requested by the electric vehicle than the power output of the GEG 102 (e.g. up to 60 kW and lower), any excess power from the GEG 102 can be diverted to charge the accumulator batteries in the array 104. However, if the accumulator batteries are already fully charged or have insufficient temperature for effective charging, the bus voltage will increase. In this case, the controller may set a voltage limitation in the system 100 at 582 V, so that should the voltage limitation be reached, a current feedback regulator may come into operation, which controls the GEG current output and provide voltage stabilization at the 582V limit.

Yet another specific example is described below, when both the battery array 104 and the GEG 102 are providing power to the charging port 110 through the DC-DC converter 106.

In this example, the voltage of the GEG 102 is increased until the current output of the GEG 102 stabilizes with a rated value set by the controller 108. The current output value for the GEG 102 is determined based on the power required for charging the battery array 104 and for the load required for charging a connected EV battery. As the maximum power output of the GEG 102 is reached, the controller 108 constantly monitors the voltage on the bus (i.e. the combined voltage of the GEG 102 and the battery array 104), and limits the GEG power output if the bus voltage exceeds a set value. Concurrently, as the system increases the load power—voltage drops, the generator power increases again. This process continues until the maximum power output is reached. With a sufficiently great load, the limitations on the upper limit of the voltage are of little importance as a result of battery voltage drop to the middle point within the upper and lower limits, which mean that voltage fluctuations are negligible.

To describe this example in another way, when the battery array 104 is under load (i.e. when the load power required by the system to charge a connected EV battery increases), the bus voltage drops and the GEG current increases. It is then important for the control signal from the controller 108 to control the GEG power output, which may include constantly reducing the GEG power output for a period of time, to prevent the generator 102 from overloading. When the battery 104 reaches the rated load value (set by the controller 108), the bus voltage is stabilized and only minimal adjustment of the GEG 102 is needed, e.g. to compensate for changes in EV consumption.

When the battery array 104 is depleted, the output voltage drops rapidly, which causes a load build-up on the GEG 102, the controller 108 monitors the drop and in response constrains the GEG current output to a level of the maximum GEG power, such that the overall system 100 reduces the power supply charging load available for charging the electric vehicle.

FIG. 2 shows a power system 200 according to another embodiment of the present invention. The power system 200 includes a power distribution system comprising a gas engine generator 202 (GEG), an array 204 of accumulator batteries (also known as a power bus), a direct current-to-direct current converter 206 (DC-DC converter), a controller 208, and a charging port 210, which operates in a similar way to the power distribution system 100 described above in reference to FIG. 1. The power system 200 further includes a liquefied natural gas fuel system comprising a cryogenic tank 212 for the LNG fuel, a heat exchanger 214, a diverter 216, a heater 218, and a LNG fuel system controller 220.

The system 200 may be mounted on a vehicle or vessel to provide a mobile charging unit. For example., the system 200 is mounted on the truck chassis with gas, electrical or otherwise drive, and combines the functions for energy generation, storage and distribution at various EV charging stages. As will be understood, the LNG fuel system provides a mobile fuel supply for the GEG 202.

The GEG 202 for a truck-mounted system may be a low power generator of 20 to 100 kW power capacity.

The general operating principle of a mobile power system 200 is that as the system 200 moves around (e.g. driving across a city between charging/discharging stops), the GEG 202 produces power using the liquefied natural gas. The produced power is accumulated in the batteries of the array 204. It has been found that it typically takes about 30 minutes to completely charge a battery array 204 having eight 66V accumulator batteries. Upon arrival at a charging location (i.e. an EV requiring a charge), the charging port 210 is connected to the electric vehicle and the charging process starts. Generated power from the GEG is transferred to the electric vehicle, and when the maximum charging power of the GEG is reached, the system 200 discharges power from the battery array 204 to provide for supplementary charging. Upon completion of the charging session, the cycle repeats where the GEG 202 returns to charging the accumulator batteries in the array 204 as the mobile system 200 moves to its next destination.

It is also possible for the accumulator batteries in the array 204 to be swapped or switched with the EV battery at a destination, if compatible. In other words, the body of the vehicle can be designed to provide a compartment for accumulator batteries having a same format as on the battery or batteries of the EV to be charged, such that batteries can be easily interchanged between the mobile system 200 and an electric vehicle.

In this example, the cryogenic tank 212 provides a capacity to store 500 litres of LNG. This typically provides 20 hours of continuous operation of the GEG or 20 charge-discharge cycles, 20 charging sessions of 20-30 min each.

In use, LNG is directed from the cryogenic tank 212 toward the diverter 216 where it is further directed toward the heat exchanger 214 to be vaporised into a gaseous form of natural gas. The natural gas is then re-directed through the diverter 216 to the heater 218, where it is heated to a temperature suitable for the GEG 202 to consume and generate power. The direction of LNG and natural gas through the LNG fuel system is controlled by the LNG fuel system controller 220.

Specifically, the LNG fuel system controller 220 is able to provide sustainable start and operation of the motor across the entire range of running temperatures. Further, the LNG fuel system controller 220 may also control the exhaust gas composition to obtain optimum performance of the GEG.

As will be appreciated by the skilled person, the power distribution system 200 may require cooling during operation, in particular the engine and intercooler components of the GEG 202, the array 204, and the DC-DC converter 206. In the known systems, these components are often cooled by air, water or another dry cooler heat exchange system. In the present power distribution system 200, the piping between the diverter 216 and the LNG heat exchanger 214 may be directed through or around the GEG 202 and other components in the system 200 (such as pass the power bus 204 and/or the DC-DC converter 206) to provide supplementary heat exchange to these components. In this way, the LNG or the cooler natural gas (after vaporisation and before heating by the heater 218) may be efficiently used to cool down hotter components across the system 200 and/or heat the LNG/vaporised LNG to reduce the energy demand of the heat exchanger 214 and/or the heater 218.

In an alternative example, the system 200 may also be deployed as a stationary unit, for example in a remote or rural, or even urban, location that is not connected to a mains gas supply, and the cryogenic tank 212 may be refuelled as required. The power for maintaining the LNG fuel system may be drawn from the power distribution system 200 or a separate power supply may be used, as will be apparent to the skilled person.

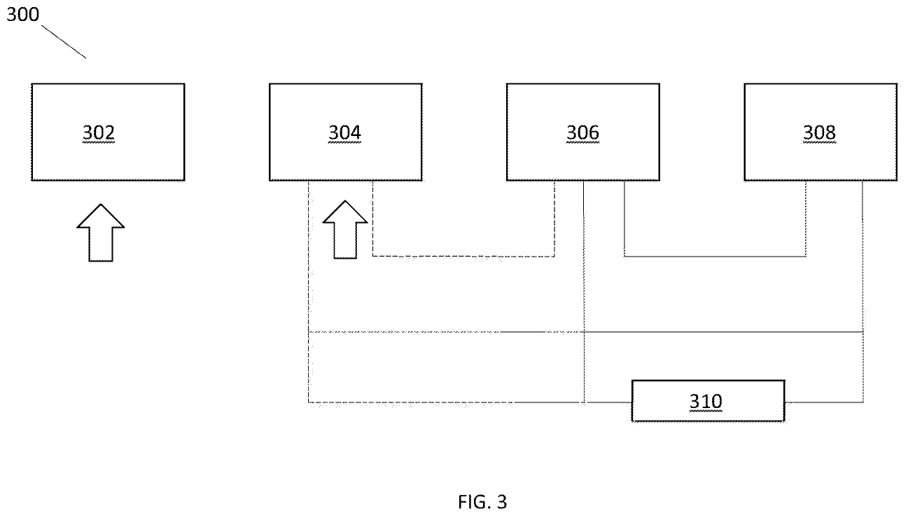

FIG. 3 shows a schematic of a power system 300 with a cooling system according to another embodiment of the present invention.

The key components in the power system 300 that require cooling include the DC-DC converter 302, the battery array 304, the engine intercooler 306 and the gas engine 308. Typically the DC-DC converter 302 and the battery array 304 are air cooled, although in some cases the battery array 304 may be connected to a further heat exchange cooling system 310, such as a dry cooler.

The intercooler 306 and the gas engine 308 are typically cooled by a dry cooler heat exchange system 310. This closed system 310 may use water or an antifreeze as a medium in the heat exchange piping, where dry air passes over the piping to draw heat out of the water/antifreeze, and where the cooled medium is passed by through the system 300 to absorb heat from the components 304, 306 and 308.

As explained above in reference to FIG. 2, the LNG fuel system piping may be directed to pass alongside at least a portion of the dry cooler heat exchange piping so that the cooler LNG or vaporised LNG can draw heat away from the heat exchange piping of the dry cooler system 310.

In another example, in which the power system 100, 200 is mounted on a vessel such as a boat or ship, the heat exchanging piping can be routed to pass through the body of water on which the vessel sits. In this way, the heat exchange system 310 is a closed system, like a dry cooler system, but benefits from the surrounding water to provide enhanced heat exchange like a cooling tower/wet cooling system.

1. A power distribution system comprising:
a charging port for connection to an electric vehicle, EV, battery;
a gas engine generator, GEG, configured to generate a first current output;
an array of accumulator batteries configured to generate a second current output;
a direct current to direct current, DC-DC, converter configured to receive the first and second current outputs and to output a regulated power supply to the charging port; and
a controller configured to independently control:
the GEG to determine the first current output;
the array to determine the second current output; and
the DC-DC converter to determine the regulated power supply.

2. The power distribution system of claim 1, further comprising a GEG voltage regulator, wherein the GEG voltage regulator is controllable by the controller.

3. The power distribution system of claim 1, wherein the array comprises a battery management system, BMS, for each accumulator battery, and wherein the second current output is controlled using information from the battery management systems in the array.

4. The power distribution system of claim 3, wherein the information comprises a maximum voltage and a minimum voltage of each of the accumulator batteries, and wherein the second current output is determined using a highest maximum voltage and/or a lowest minimum voltage across all of the accumulator batteries.

5. The power distribution system of claim 3, wherein the information comprises a maximum temperature and a minimum temperature of each of the accumulator batteries, and wherein the second current output is determined using a highest maximum temperature and/or a lowest minimum temperature across all of the accumulator batteries.

6. The power distribution system of claim 1, wherein the accumulator batteries are connected in series in the array.

7. The power distribution system of claim 6, wherein the array comprises eight accumulator batteries.

8. The power distribution system of claim 1, wherein the controller is configured to determine a maximum input power capacity of an EV battery connected the charging port.

9. The power distribution system of claim 8, wherein the controller is configured to control the DC-DC converter to output a maximum regulated power supply to the charging port, preferably wherein the maximum regulated power supply matches the maximum input power capacity.

10. The power system of claim1, further comprising a fuel supply.

11. The power distribution system of claim 10, preferably wherein the fuel comprises one or more of: natural gas, liquefied natural gas, LNG, biofuel, hydrogen, and/or a hydrogen-methane blend.

12. The power distribution system of claim 1, further comprising a renewable energy system configured to charge the array and/or deliver a third current output to the DC-DC converter, wherein the renewable energy system is controllable by the controller.

13. The power distribution system of claim 1, wherein the power distribution system is mounted on a vehicle or vessel, preferably wherein an engine of the vehicle or vessel is configured to charge the array and/or deliver a further current output to the DC-DC converter.

14. The power distribution system of claim 1, further comprising a cooling system.

15. The power distribution system of claim 14, wherein the power distribution system is mounted on a vessel, and wherein the cooling system is configured to exchange heat with water surrounding the vessel.

16. The power distribution system of claim 14, further comprising a LNG supply system, wherein the cooling system is configured to exchange heat with liquefied natural gas of the LNG supply system before vaporisation.

17. A method of providing a regulated power supply for an electric vehicle, EV, battery, comprising:
providing a gas engine generator, GEG, configured to generate a first current output;
providing an array of accumulator batteries configured to generate a second current output;
controlling, by a controller, the GEG to output the first current output;
controlling, by the controller, the array to output the second current output;
receiving, at a direct current to direct current, DC-DC, converter the first and second current outputs; and
controlling, by the controller, the DC-DC converter to output a regulated power supply to a charging port.

18. A non-transitory computer-readable storage medium storing instructions thereon which, when executed by a processor in a controller, cause the processor to perform a method of providing a regulated power supply for an electric vehicle, EV, battery, the method comprising:
controlling a gas engine generator, GEG to output a first current output;
controlling an array of accumulator batteries to output a second current output; and
controlling a direct current to direct current, DC-DC, converter configured to receive the first and second current outputs to output a regulated power supply to a charging port.
